(19) United States
(12) Patent Application Publication
(10) Pub. No.: US 2011/0037844 A1
(43) Pub. Date: Feb. 17, 2011

(54) ENERGY EMITTING DEVICE

(76) Inventors: Scot Johnson, Tampa, FL (US); Daryl Johnson, Pompano Beach, FL (US)

Correspondence Address: Scott David Compton (The Compton Law Firm, P.C.), 2386 S. Dairy Ashford St. #593, Houston, TX, 77077, US

(21) Appl. No.: 12/858,429

(22) Filed: Aug. 17, 2010

Related U.S. Application Data
(60) Provisional application No. 61/274,412, filed on Aug. 17, 2009.

(51) Int. Cl. H04N 7/18; H04N 5/33; H04N 5/30

(52) U.S. Cl. 348/77; 348/164; 348/162; 348/E05.09; 348/E07.085; 348/E05.085

(57) ABSTRACT

The present application is directed to a radiant energy emitting device, comprising (1) a targeting means operationally configured to repeatedly identify a target surface area; (2) an image recording means for recording one or more images of a target surface area; and (3) a powered energy source housed within the device operationally configured to emit energy; wherein the device is operationally configured to concentrate energy emitted from the energy source out through an aperture of the device toward the target surface area.

### CROSS-REFERENCE TO RELATED APPLICATIONS

The application is entitled to the benefit of the filing date of the prior-filed provisional application No. 61/274,412, filed on Aug. 17, 2009.

### STATEMENT REGARDING FEDERALLY SPONSORED RESEARCH OR DEVELOPMENT

Not applicable.

### FIELD OF THE APPLICATION

The application relates generally to radiant energy emitting devices for transmitting radiant energy to a target surface and methods of use thereof.

### BACKGROUND

Advances in medical technology are ongoing. However, known medical technologies are limited by the current state of electronic components available to designers. Ideally, new electronic components lead to new medical technologies, faster procedures, better patient results and improved patient compliance. However, currently available electronic components have been provided in separate and often complimentary medical technologies as opposed to integrating several technologies together in a manner that may otherwise assist health care providers.

In practice, health care providers are continually investigating the pathways of the conditions they treat, the affects of those conditions on their patients, methods for quantifying the extent of conditions' progressions and treatments, the manner in which conditions may effect patients, and for comparing one condition to one or more other conditions in professionally acceptable and potentially statistically relevant standard formats. For example, in a clinical study format there typically exists the time and directive to collect as much information as possible from sources such as questionnaires and other diagnostic or qualitative methods prior to, during, and after a medical treatment via a medical device and/or medical drug. In common health care environments, there is typically no time for such documentation and analysis, nor are there the separate types of desirable equipment available to collect the various data relative to a particular treatment.

There exist several types of medical and aesthetic conditions which have become widely treatable in recent years, particularly with the advent of high powered radiant energy delivery devices but also including various ultrasound and heat-generating devices. One particular technology being implemented in medical procedures includes camera technology, both in miniature and with high resolution. To date, cameras about 0.050 inches in diameter or less are used in medical devices such as endoscopes. Similar to cameras used in cell phones, algorithms for identifying differences and ratios within a digitally recorded image are currently available. Known cameras are typically sensitive to non-visible electromagnetic radiation, including infrared wavelengths, and many conditions for which radiant energy emitting devices are applicable may provide medically relevant information when exposed to non-visible wavelengths.

In the 21^{st} century, medical patients are increasingly more informed and aware of their physical well-being and any medical condition affecting him or her. For example, patients are increasingly communicating with each other via the internet as to prospective treatments or procedures best suited for their condition. As a result, today's patients are more informed and inquisitive regarding a health care provider's recommendations, are more interested in in-depth examination and analysis regarding a course of treatment over time, and are more likely to share their own experiences with others suffering from a similar condition. To improve both patient trust and compliance, various standard quality of life questionnaires, digital images of treatment progression, and quantitative identification of differences relating to treatment efficacy in a series images of the patient's treatment site(s) have been implemented in recent years. Furthermore, medical insurers are increasingly requesting additional information and proof of treatment efficacy before a full reimbursement is provided. For such institutions, standard quality of life questionnaires, digital images of treatment progress, and quantitative identification of differences relating to treatment efficacy in a series of images related to a patient's treatment may greatly improve ease of and magnitude of medical reimbursement.

Integration of technologies including for example, a digital camera suitably oriented for ease of use relative to the primary treatment modality, integration of standard patient data collection including quality of life, pain, pruritus, and other information in a format convenient for treatment-to-treatment assessment, methods for collecting and storing patient data and/or images in a manner convenient and integrated into a treatment or procedure with the primary treatment modality, methods for capturing image data either by visible or infrared or other illumination such that treatment-to-treatment images may be provided having substantially the same scale and orientation, methods for identifying medically relevant trends in a series of images via electronic image processing, and methods of integrating images and trends in a single, easy to understand format all utilizing available electronics and algorithms is desired.

### SUMMARY

The present application is directed to a radiant energy emitting device, comprising (1) a targeting means operationally configured to repeatedly identify a target surface area; (2) an image recording means for recording one or more images of a target surface area; and (3) a powered energy source housed within the device operationally configured to emit energy; wherein the device is operationally configured to concentrate energy emitted from the energy source out through an aperture of the device toward the target surface area.

The present application is also directed to a method for analyzing alterations to a target surface area treated with radiant energy over time, comprising (A) providing a radiant energy emitting device, comprising (1) a targeting means operationally configured to repeatedly identify the target surface area, (2) an image recording means for recording one or more images of the target surface area, and (3) a powered energy source housed within the device operationally configured to emit energy, wherein the device is operationally configured to concentrate energy emitted from the energy source out through an aperture of the device toward the target surface area, and wherein the image recording means is located adjacent the aperture; (B) directing the aperture and image recording means toward a target surface area; (C) activating the image recording means to record one or more images of the target surface area to memory; (D) quantifying image color information of the target surface area; (E) directing the aperture and image recording means toward a target surface area using the targeting means; (F) activating the image recording means to record one or more images of the target surface area to memory; (G) quantifying image color information of the target surface area; and (H) comparing image color information of the images.

The present application is also directed to a system for emitting radiant energy, comprising (A) a radiant energy emitting device including (1) a targeting means operationally configured to repeatedly identify a target surface area; and (2) an image recording means for recording one or more images of a target surface area; and (B) a console in radiant communication with the device, the console housing a powered energy source operationally configured to emit energy; wherein the device is operationally configured to concentrate energy emitted from the energy source out through an aperture of the device toward the target surface area; and wherein the console is operationally configured to display image related information.

### BRIEF DESCRIPTION OF THE FIGURES

FIG. 1 is a perspective view of an embodiment of the present energy emitting device.

FIG. 2 is a perspective view of another embodiment of the present energy emitting device.

FIG. 3 is a perspective view of an embodiment of the present energy emitting device including an energy conduit and a separate console for housing a power source and/or an energy source and for displaying information.

FIG. 4 is a perspective view of a nose portion of the embodiment of the device of FIG. 1.

FIG. 5 is a perspective exploded view of the nose portion of FIG. 4 illustrating an aperture barrier and bezel attachable to the nose portion.

FIG. 6 is a top perspective view of the device showing a display of the device.

FIG. 7 is front view of a display of the device operationally configured to provide various types of patient treatment information.

FIG. 8 is a perspective view of another embodiment of the device.

FIG. 9 is a front elevational view of the device of FIG. 8.

FIG. 10 illustrates operation of the device including targeting a skin lesion of a person's knee, the device being in an active mode.

FIG. 11 illustrates operation of the device including targeting a skin lesion of a person's knee, the device being in a non-active mode.

FIG. 12 illustrates a series of still images of a treatment site over time.

FIG. 13 illustrates a series of images taken over a series of treatments is shown and their corresponding graphical plot.

FIG. 14 illustrates a graph with plotted quantitative measures in relation to the images of FIG. 13.

FIG. 15 is a image of a graph with plotted quantitative measures plotted over time as a function of treatment frequency.

FIG. 16 depicts an exemplary Quality of Life (“QoL”) questionnaire.

FIG. 17 is a flowchart illustrating an exemplary algorithm for device operation.

FIG. 18 depicts an exemplary display screen of the present device.

FIG. 19 depicts an exemplary display screen of the present device.

FIG. 20 depicts an exemplary display screen of the present device.

FIG. 21 depicts an exemplary display screen of the present device.

FIG. 22 illustrates an embodiment of the device.

### BRIEF DESCRIPTION

It has been discovered that a radiant energy emitting device may be provided for directing radiation energy to a target surface area and recording and storing information related thereto. The device suitably includes a means for consistently re-identifying a particular target surface for multiple use applications, a means for recording and displaying images of the target surface prior to, during, and post device operation, a means for projecting onto the target surface one or more desired doses of radiant energy for target surface treatment purposes and/or for photo imaging purposes, while also having the ability to digitally record imaging information for real time and/or future use. The device suitably includes a means for conveniently incorporating qualitative measures, e.g. standard data gathering such as a questionnaire, and image collection into a standard treatment session. The device suitably incorporates algorithms for identifying and quantifying medically relevant differences in a series of images taken during treatment sessions for trend analysis or diagnosis. The device suitably includes methods for displaying treatment data, including qualitative data and images and image-based trend analyses in an easy to understand format. Heretofore, such a desirable achievement has not been considered possible, and accordingly, the system and method of this application measure up to the dignity of patentability and therefore represents a patentable concept.

Before describing the invention in detail, it is to be understood that the present device, system and method are not limited to particular embodiments. It is also to be understood that the terminology used herein is for the purpose of describing particular embodiments only, and is not intended to be limiting. As used in this specification and the appended claims, the term “radiant” or “radiant energy” is defined as the total electromagnetic energy emitted from an energy source in the form of electromagnetic waves intended to affect a target surface. Herein, the term “light” refers to radiant energy including the ultraviolet (UV), infrared (IR) and visible ranges of the electromagnetic radiation spectrum, and the term “visible light” refers to radiant energy in the visible range of the electromagnetic radiation spectrum. The phrase “target surface” refers to an animate or inanimate surface to which energy from the device is transferred. The term “treat,” “treatment” and like terms refers to affecting a target surface with radiant energy emitted from the present device. The term “skin” refers to one or more of the epidermis layer, dermis layer and subcutaneous tissue layer of animals, particularly mammals, including, but not necessarily limited to human beings. The term “tissue” refers to animal living tissue including skin. The term “quality of Life” or “QoL” refers to a patient's wellbeing, as perceived by them relative to the condition for which they are receiving treatment from a health care provider. The term “questionnaire” refers to any number of standard or non-standard forms which are known to those in the art, domestically and internationally, which typically derive qualitative data from the patient via a question and answer format. The term “pruritus” refers to the sensation commonly known as itching of the skin. The phrase “health care provider” refers to any provider of health care services.

In one aspect, the application provides an energy emission device suitable for treating human tissue with radiant energy.

In another aspect, the application provides an energy emission device operationally configured to provide clinical assessment of a treated surface.

In another aspect, the application provides an energy emission device operationally configured to allow a user to digitally view a treatment site.

In another aspect, the application provides an energy emission device operationally configured to record images of a target surface.

In another aspect, the application provides an energy emission device operationally configured to allow a user to view treatment data at point of delivery of energy from the device to a target surface.

In another aspect, the application provides an energy emission device operationally configured to identify trends, quantify differences, or measure diagnostically the extent and progression of skin wounds and skin disorders such as psoriatic lesions through a series of treatments of the target skin surface.

In another aspect, the application provides an energy emission device operationally configured to produce useful patient records in a digital medium.

In another aspect, the application provides an energy emission device including a camera and image sensor.

In another aspect, the application provides an energy emission device including a light delivery system that may be used in combination with a viewing system.

In another aspect, the application provides an energy emission device operationally configured to provide visual documentation of a skin lesion and its progression through a series of treatments.

In another aspect, the application provides an energy emission device having a display in the form of a LCD or plasma display.

In another aspect, the application provides an energy emission device including an audio speaker.

In another aspect, the application provides an energy emission device including a radio antenna.

In another aspect, the application provides an energy emission device having one or more sensors operationally configured to ascertain information such as skin temperature, oxygen saturation, glucose blood levels, or skin perspiration. Sensors may also include a CCD (charge-coupled device) camera for imaging the skin.

In another aspect, the application provides an energy emission device operationally configured to provide a health care provider with information necessary to modify or otherwise adjust the intensity of the energy source as desired.

In another aspect, the application provides an energy emission device including an alarm means for notifying a user when a particular device parameter has gone beyond an acceptable range.

In another aspect, the application provides an energy emission device effective for improving patient documentation and assisting health care providers with means to better assess the efficacy of their own treatment methods and how such relate to patients. Improved patient documentation may also demonstrate to patients how their particular condition is progressing through treatment.

In another aspect, the application provides an energy emission device including a proximity sensor effective to prevent unintended operation of the device.

In another aspect, the application provides an energy emission device, systems and methods for integrating (1) a radiant energy emitting device for transmitting radiant energy to a target surface, (2) a camera for capturing images of the target surface over a series of treatments, (3) a display for viewing images and for identifying the proper orientation of the camera for new images with respect to previous images for scale, (4) data collection such as quality of life, pain and pruritis questionnaires, (5) identifying differences in a series of images which are medically relevant and quantifying those differences for trend analysis or diagnostic measurement, (6) displaying quantitative values, e.g., from questionnaires and standard forms, and trend analysis of stored sequential images, in graphical format which includes sequential images such that health care providers, insurance reimbursement firms, and medical patients may readily access information, and (7) a means for transferring treatment information conveniently to external memory devices for record keeping purposes.

In another aspect, the application provides an energy emission device, used in combination with information gathered via a questionnaire including, but not necessarily limited to the Psoriasis Quality of Life questionnaire (® 2003 JYM Koo and M. Alan Menter) as recognized by persons of ordinary skill in the art of dermatology.

### Discussion of the Device, System and Method

To better understand the novelty of the device, system, and method of use thereof, reference is hereafter made to the accompanying drawings. Generally, a radiant energy emission device for target surface treatment is provided, having one or more additional devices for illuminating and recording a series of images of the target surface in similar scale and orientation, means for collecting qualitative data from a patient, means for identifying trends in a series of images, means for incorporating recorded images and qualitative data into real time treatment procedures, and means for displaying treatment data, qualitative data, images and image-related trends into an easy to understand format.

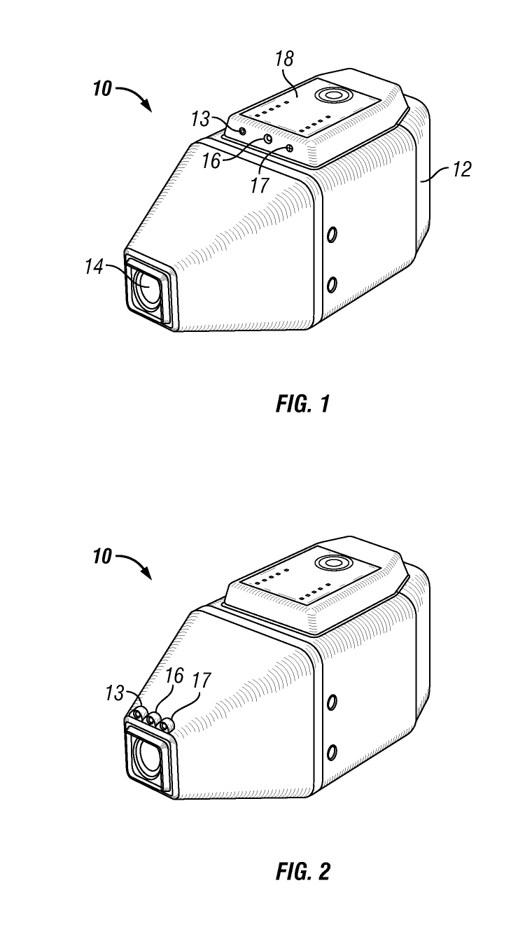

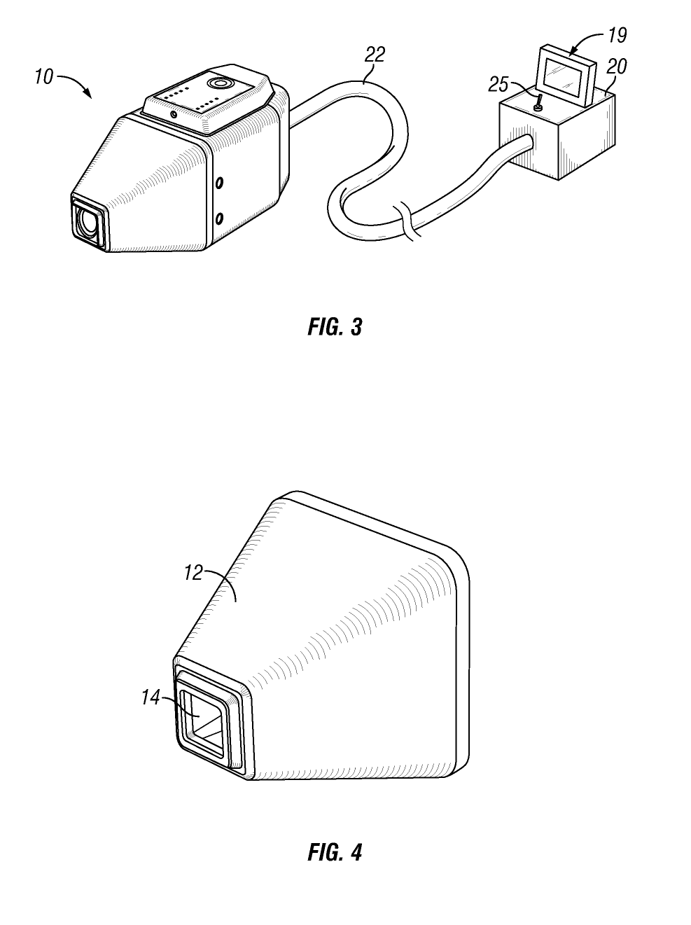

With reference now to a simplified illustration of the invention as provided in FIG. 1, an energy emitting device 10 is provided having (1) an outer protective housing 12, (2) an opening or aperture 14 there through, (3) an energy source (not shown), (4) an image recording means 16, (5) an illumination source 13 for use in recording images, (6) a distance sensor 17 for recording the distance from a target surface to the image recording means 16, and (7) an input/output display or display screen 18. Suitably, the housing 12 is operationally configured to contain energy in a manner effective to limit energy emission through only the aperture 14. As FIG. 1 illustrates, the image recording means 16 is directionally aligned substantially similar to the aperture 14, i.e., both the aperture 14 and image recording means 16 suitably face the same direction. As such, the placement of the image recording means 16 along the device 10 may vary as illustrated in FIG. 2. Although not limited to a particular embodiment and subject to change with advances in technology, a suitable image recording means 16 includes, but is not necessarily limited to a CCD camera operationally configured to produce multiple-megapixel-resolution images and/or video.

In one embodiment, the camera 16 may include a fixed focus lens. In another embodiment, the camera 16 may include an autofocus lens or a series of lenses.

In one embodiment, the device 10 may be powered via a common wall outlet. In another embodiment, the device 10 may be powered by a separate power supply. In still another embodiment, the device 10 may be self powered, i.e., battery powered with either or both rechargeable battery means or disposable battery means.

Suitably, the device 10 is operationally configured to receive radiant energy therein and allow for the emission of radiant energy out through the aperture 14 toward a target surface. As shown in FIG. 3, the radiant energy source may be housed within a separate console 20 apart from the device 10 whereby the console 20 is in radiant communication with the device 10 via a radiant energy conduit 22 or optical tether effective for linking the console 20 to the device 10. Suitable radiant energy conduits 22 include, but are not necessarily limited to fiber-optic conduit, fluid-filled conduit, light pipe, antennas, and prisms.

It is also contemplated that the console 20 may be operationally configured to provide both power and radiant energy to the device 10. In still another embodiment as discussed below, a device 10 may also be provided having its own radiant energy source arranged within the housing 12 while being powered by a separate power source. In a particularly advantageous embodiment, the device 10 may be provided with a radiant energy source fitted within the housing 12 effective for the device 10 to be handheld during use, eliminating the need for a separate energy source and conduit 22.

With reference to FIG. 4, the aperture 14 is suitably operationally configured to allow for the passage of radiant energy there through while simultaneously providing a seal for the housing 12 against external influences such as the intrusion of liquids, dirt, dust, and other solid objects that may affect the working components of the device 10. For the purpose of this application, the term “aperture” refers to the point along the device 10 where radiant energy exits the device 10.

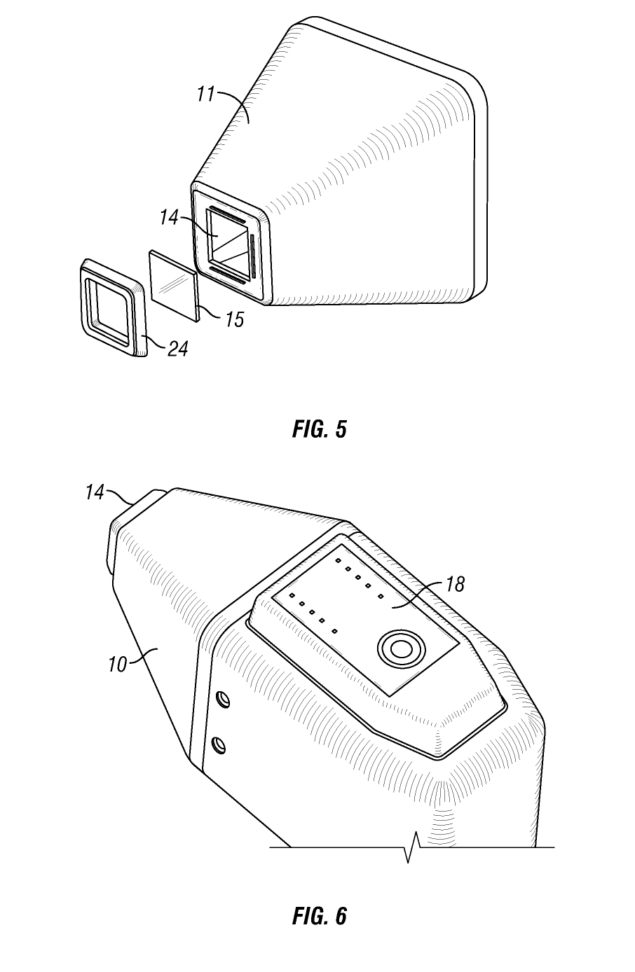

As shown in FIG. 5, the aperture 14 suitably includes a physical aperture barrier 15 separating the energy source within the housing 12 from the ambient environment outside the device 10. For the purpose of this application, a suitable aperture barrier 15 is sufficiently transparent to radiant energy. Although not limited to a particular material of construction, suitable aperture barriers 15 are constructed from materials including, but not necessarily limited to sapphire, quartz, glass, polymeric material, metallic surfaces, and combinations thereof. Preferably, an aperture barrier 15 is constructed from a medium that provides the best combination of transmissivity and durability for a particular electromagnetic radiation. In one particularly advantageous embodiment of a device 10 provided with an UV light energy source, the aperture barrier 15 may include an optical window constructed from sapphire. In another particularly advantageous embodiment of a device 10 provided with an UV light energy source, the aperture barrier 15 may include an optical window constructed from UV grade fused silica. For referencing purposes, the aperture 14, and image recording means 16, may be considered as being located on the front side of the device 10. Thus, in operation the aperture 14, and image recording means 16, suitably face a target surface while the operator of the device 10 is suitably positioned opposite the aperture 14 toward the back side of the device 10.

In the particular embodiment of FIG. 5, the aperture 14 is disposed along a portion of the housing 12 herein referred to as a nose 11 of the device 10, the nose 11 including an inner surface configuration effective to focus emitted energy from the energy source of the device 10 toward the aperture 14 in a manner effective for radiant energy to exit the aperture 14 toward a target surface. In addition, it is also contemplated that the aperture barrier 15 may be operationally configured to focus energy out from the device 10. Further still, the device 10 may also include a conduit for directing energy from an energy source of the device to the aperture 14. In such embodiment, the inner surface configuration of the housing 12, the aperture barrier 15, and conduit materials therein may be used in any combination to yield a beam of energy of particular output intensity from the device 10.

With further reference to FIG. 5, the device 10 may comprise a bezel 24 for providing a perimeter border for the aperture 14, the bezel 24 being operationally configured to detect the presence of a target surface out in front of the aperture 14. In an embodiment of operation of the device 10 where the aperture 14 is to contact a target surface, e.g., contacting a patient's skin for administration dose(s) of therapeutic energy, the bezel 24 is suitably the first part of the device 10 to contact the target surface. In one suitable embodiment, the bezel 24 may include a resilient means for physical movement or compression of the bezel 24 as the bezel 24 contacts a target surface. In another embodiment, the nose 11 may include a resilient means for physical movement or compression of the nose 11 against the remaining housing 12 as the bezel 24 contacts a target surface.

In another embodiment, the bezel 24 may include one or more pressure sensors where as a target surface is detected either mechanically or electronically energy is suitably transmitted from the raised border 24 to the one or more pressure sensors. In another embodiment, the device 10 may include a proximity sensor (not shown) such as a capacitance sensor for detecting the surface of a patient's skin. Once the device 10 detects the presence of skin within a predetermined proximity to the device 10, the device 10 may be operationally configured to automatically emit radiant energy, or provide for manual radiant energy emission activation. In the absence of a target surface, the device 10 is suitably disabled wherein the device 10 is not able to emit radiant energy.

In another embodiment, the bezel 24 may be utilized to make a temporary indention on a target surface effective to provide a device 10 operator with a means for identifying a prior treatment locale along the target surface. Once a dose is applied to a target surface, an operator may effectively apply further doses to surface areas other than prior treatment locales. In still another embodiment, the bezel 24 may be operationally configured to provide a seal along the perimeter of a target surface area effectively containing radiant energy therein during operation of the device 10.

Although not limited to a particular configuration, the bezel 24 may be (1) releasably attachable to the housing 12, and (2) operationally configured to maintain the aperture barrier 15 in a sealed position across the aperture 14 during operation of the device 10. The bezel 24 may be attached to the nose 11 via threaded fasteners such as screws. In another embodiment, the bezel 24 may be configured to screw or snap directly into the housing 12 of the device 10. As desired, one or more seals may be incorporated to ensure that the aperture 14 is sealed along its perimeter during operation of the device 10. Suitable seals include, but are not necessarily limited to o-rings and gasket materials. In still another embodiment, the bezel 24 may be provided as a permanent fixture of the device 10, or simply as part of the housing 12 during manufacturing.

Although not limited to a particular material of construction, the bezel 24 is suitably constructed from a like material as the housing 12 and nose 11. As such, the various components of the device 10 are suitably constructed from one or more materials including but not necessarily limited to those materials resistant to chipping, cracking, excessive bending and reshaping as a result of ozone, ultra-violet radiation, weathering, heat, moisture, other outside mechanical and chemical influences, as well as various impacts and other loads placed on the device 10. Suitable materials of construction include, but are not necessarily limited to metals, polymeric materials, rubbers, woods, fiberglass, filled composite materials, and combinations thereof. In a particularly advantageous embodiment of the device 10 for treating human tissue with radiant energy, the housing 12, nose 11, and bezel 22 are suitably constructed from a molded plastic and the aperture barrier 15 is suitably constructed from fused silica.

Turning to FIG. 6, the device 10 is suitably provided with an input/output display 18 or screen as shown. The actual location of the display 18 along the device 10 may vary, however, being located along the top of the device as shown in FIG. 6 may be advantageous for operator ease of use. Depending on the intended use of the device 10, the display 18 may include one or more input/output characteristics including but not necessarily limited to power or battery status, radiant energy emission status, device temperature, the total number of doses emitted, and patient identification information.

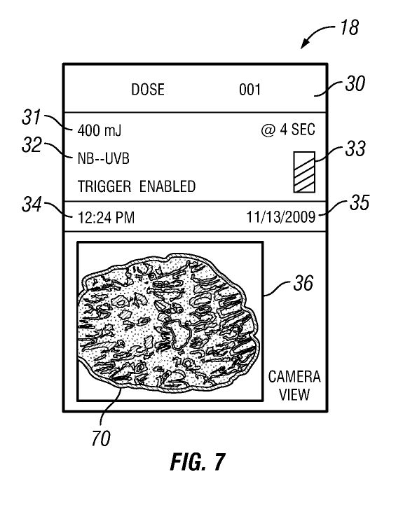

In a particularly advantageous embodiment, the display 18 may include an interactive multi-touch screen display similar to those used in cellular phones such as liquid crystal displays (“LCD”), vacuum fluorescence displays (“VFD”), or one or more of high contrast 7-segment and LED indicators as known in the art. As explained in detail below, the display 18 may provide various types of information depending on the particular function of the device 10. For example, a device 10 operationally configured to deliver UV light to a person's skin, commonly referred to as “targeted UV phototherapy,” may provide information as shown in the simplified illustration of FIG. 7. For example, the display 18 may provide patient treatment information including, but not necessarily limited to (1) dose counts 30, (2) strength of dose 31, (3) the energy source 32, (4) battery power 33, (5) time 34, (6) date 35, and (7) a color image 36 taken via a camera 16 of the device.

In another mode of operation, information may be communicated to an operator via audible sound or visible light as desired. Here, the device 10 may contain light sources such as UV light, infrared distance sensors, and/or white light in the aperture 14 region. Information including dosage number and dosage amount may be displayed on a 7-segment LED display thereby notifying the device 10 operator. Other LEDs of various colors might be used to indicate when the device 10 is armed/disarmed for emitting radiation, and when the device 10 is actually emitting therapeutic light, etc. Audio, such as from a small speaker, may be used to indicate similar types of information in addition to or in place of visible light.

As previously stated, activation of the energy source may be controlled directly by a power source. In particular, the device 10 may include a power switch in communication with the energy source, whereby the energy source may be powered by (1) a separate power source located in a separate console 20 (see FIG. 3), (2) plugging the device 10 directly into a wall outlet via a power cord, or (3) the device 10 may be self powered, i.e., battery powered. In one mode of operation, the device 10 may be wholly automated. In another mode of operation, a power switch may be provided to allow for manual operation of the device 10. A suitable power switch includes electrical connections such as wires (not shown) providing electrical communication between the energy source, e.g., an LED array, and a power source. In this implementation, a switchable power source may selectively provide either a continuous or pulsed operation of the diode banks. In one continuous mode of operation of the device 10, a selector switch may be used to interconnect a power supply to LED die. In pulsed operation of the device 10, small bursts of electrical power may be delivered to the LED array at various frequencies and for various durations, potentially in an attempt to increase LED lifespan and reduce energy consumption. Although not limited to any one mode of operation, suitable manual power switches include, but are not necessarily limited to bush-button switches, toggle switches, rocker switches, slide switches, and foot pedals. Although the placement of the power switch may vary, a suitable power switch is located in convenient proximity to the operator of the device 10.

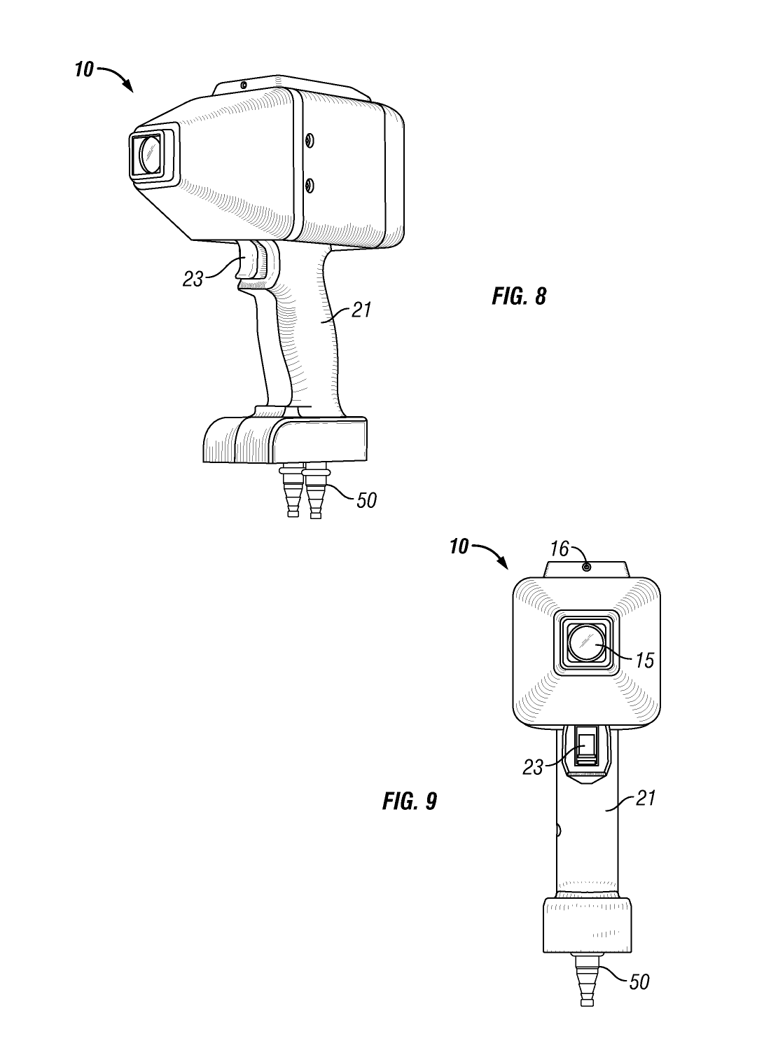

In another embodiment, activation of the energy source may be controlled by a separate energy activation switch 25 as shown in FIG. 3. In a particularly advantageous embodiment of the device 10 as shown in FIGS. 8 and 9, the device 10 suitably has a pistol type grip 21 including an energy activation switch in the form of a two-way trigger 23 providing for hand held operation of the device 10 and finger activation of the energy source via the trigger 23.

Similar as the power source, suitable energy activation switches 25 may include, but are not necessarily limited to bush-button switches, toggle switches, rocker switches, slide switches, and foot pedals. In addition, the embodiment of the device 10 as shown in FIGS. 8 and 9 is suitably operationally configured for ambidextrous use in both substantially vertical and substantially horizontal positions of the device 10.

As further shown in FIGS. 8 and 9, in an embodiment where the energy source 18 is housed separate from the device 10, the device 10 may include one or more connectors 50 for releasable or permanent attachment of the device 10 to a radiant energy conduit 22. In a battery powered embodiment of the device 10 of FIGS. 8 and 9, one or more connectors 50 may be included for recharging and facilitating electronic communications for the device 10. Thus, the device 10 may be provided with a separate docking station for recharging purposes, or the device 10 may be provided with charging cables, such as USB charging cables, or other custom wire harnesses as desired. As technology advantages, other means may be provided for recharging purposes, including for example, wireless energy transfer.

Depending on the total number of features to be implemented into the device 10, one or more commercially available electronic components may be incorporated into the device 10 as necessary. Examples include, but are not necessarily limited to, analog-to-digital and digital-to-analog conversion chips, digital signal processors, microprocessors, memory, radio frequency amplifiers, and CCD cameras. For example, a Bluetooth or 802.11g system may be implemented to wirelessly communicate information from the device 10 to a console 20, computer, or other device. As shown in FIG. 3, the console 20 may include its own display 19 operationally configured to visually reproduce the display 18 information of the device 10 in real time.

Although various frequencies of various energy sources may be implemented to treat known skin conditions, the following description will discuss treating psoriasis using UV light, a type of treatment hereafter referred to as “targeted UV phototherapy.” UV light is electromagnetic radiation with a wavelength shorter than that of visible light, but longer than X-rays, in the range from about 10 nm to about 400 nm, and energies from about 3.0 eV to about 124 eV. The three main types of UV light discussed herein include (1) UVA having wavelengths in the range from about 400 nm to about 320 nm; (2) UVB having wavelengths in the range from about 320 nm to about 280 nm; and (3) UVC having wavelengths in the range from about 280 nm to about 100 nm. For treating psoriasis, die-level LEDs are suitably provided for emitting wavelengths from about 395 nm to about 300 nm.

Psoriasis is a skin condition that causes skin redness and irritation. Psoriasis can affect the skin, fingers, toe nails, the joints (psoriatic arthritis), and has been linked with generally poorer immune responses to other illnesses and slower recovery times. While there are several forms of a psoriatic outbreak, the most common type is psoriasis vulgaris, also known as plaque psoriasis. Plaque psoriasis is evidenced by patches of skin which may appear red and inflamed and be covered by silvery white scaly skin. These areas are typically described as being sore and itchy. Other forms of psoriasis may appear as spots or other shapes and may contain pustules, structures that ooze pus.

To date, various forms of UV light have been implemented in an attempt to treat psoriasis. UV phototherapy treatments typically focus on administration of sub-erythemic dosages (“SEDs”) and multiples of a minimum erythemic dose (“MED”). The MED is unique for each patient and refers to the minimum irradiance necessary to cause visible reddening of skin after a certain period of time of exposure to radiation, e.g., UV light. Known devices that administer SED level UV dosages are referred to as “non-targeted UV phototherapy” devices, because these devices often administer UV light to a patient's entire body or large surface areas unnecessarily affecting healthy skin or non-target skin along with the target skin surface area to be treated, and thus cannot deliver greater than a patient's MED without burning or otherwise affecting healthy and/or non-target skin. Conversely, targeted UV phototherapy devices administer more intense UV light, at multiples of a patient's MED, and generally to small body surfaces treating substantially only the target skin surface sparing healthy and/or non-target skin.

Regarding UV light sources used to treat psoriatic lesions, exposure to direct sunlight, and conventional illuminators such as UV light bulbs and UV fluorescent lamps, as well as UV-generating gas arc lamps, excimer lasers, and excimer light sources are currently employed. However, it is difficult to limit sun exposure to only the target surface area of the skin. Also, with regard to targeted UV phototherapy, i.e. administering multiples of a patient's MED per dose, arc lamps and lasers have several drawbacks. For example, in addition to having low life spans (approximately 300 hours or less) the high intensity light output from arc lamps requires optical filtering to potentially eliminate UVC emissions and reduce UVB emissions below 300 nm. The high intensity UV light from excimer laser sources is monochromatic and within a suitable therapeutic wavelength range, but is more costly than arc lamps and requires greater maintenance. To overcome these types of drawbacks, the present device 10 employs one or more Light Emitting Diodes (“LEDs”) fabricated in a manner effective to provide substantially even exposure of a target surface of skin with UV light, long energy source life, and suitably limited maintenance.

A suitable LED assembly (not shown) includes die-level LED technology as understood by persons of ordinary skill in the art of LEDs. LED die are suitably mounted to a sub-mount wherein the sub-mount has conductive traces and conductive surfaces through which an LED die cathode and anode may be connected.

LEDs provide a UV light source that is lightweight, small in size, durable, having an emission spectra approximating a known monochromatic laser profile. UV LED technology affords a light emission spectra that does not require optical filtering of undesired wavelengths. Die-level LED assemblies are suitably utilized for smaller, lower profile designs suitable for use with a handheld type device 10 as shown in FIGS. 8-11. Appositely, die-level LED assemblies may be mounted directly to a printed circuit board in a larger number per unit area than other known illuminators.

Although not limited to a particular configuration, desired LEDs are suitably arranged in a pattern over a surface area to emit light from the LEDs, which is directed toward a target surface. As of the date of this application, LED die are commercially provided in a range of about 395 nm to about 300 nm and typically emit about 50 mW/cm² or less.

Depending on the severity of the psoriasis and the surface area of the target lesion, a suitable device 10 may be operationally configured to provide an array of at least several hundred LED die with near to about 310 nm peak wavelength effective for emitting approximately at least hundreds of mW/cm² intensity. For exemplary purposes only, if a surface area of the target lesion is about 4 cm², then a typical intensity from about 50 to about 250 mW/cm², and in some instances even 1.0 W/cm² or more may be required to treat a lesion. As LED technology progresses, less LED die may be required to achieve current optical output intensities. It is also contemplated that LEDs of this application may be further capable of emitting white-light or any portion thereof, e.g., blue-light, as desired.

To be viewed as comparable with other known technologies as of the filing of this application, a suitable device 10 may include an array of 310 nm LEDs consisting of ten substantially parallel rows, each row containing twenty LED die, the array emitting at least about 50 mW/cm² of light intensity.

As desired, an LED array of the device 10 may also include various thermal management characteristics. As understood by persons of ordinary skill in the field of electronics, an array may be arranged wherein each LED die is fixed to a substrate within a cavity or like structure via one or more heat spreading materials to reduce thermal resistance wherein the design of the substrate also works to transfer heat away from the LED during use. Here, suitable heat spreading materials include, but are not necessarily limited to silicon, ceramic materials, sapphire, metals with high thermal conductivity, and combinations thereof.

Other thermal management characteristics may include (1) providing LED arrays utilizing (a) thermally conductive adhesives when and where adhesives are required, and (b) metal core printed circuit boards (“MCPCB”) to act as improved heat spreaders; (2) attaching LED arrays to an MCPCB via small mounting screws to ensure good thermal transfer; (3) providing LED arrays making use of high thermal conductivity material heat sinks with large surface areas and mounting such heat sinks with mounting screws as opposed to an adhesive; (4) providing LED arrays utilizing thermoelectric cooling devices; (5) incorporating small fans into the device 10 to extract heat away from the LED array; (6) locating all powered LED driving circuitry apart from the LED dies, as circuitry may generate heat that may otherwise contribute to heat generated by the LED array; (7) utilizing liquid-cooled heat sinks to transfer heat away from the substrate, and (8) routing air flow through the device 10 such that cool air may be directed across any hot surfaces of the LED array and thereafter directed away from the LED array.

### Operation of the Device

For purpose of this application, operation of a device 10 similar to those shown in FIGS. 8-11 is discussed in terms of treating psoriasis. Although the device 10 may be used in many environments and by any individual, for simplicity, the present operation is discussed in terms of medicinal treatment of psoriasis as performed by a health care provider, including methods for collecting qualitative data and recording images convenient to a normal treatment session, methods for identifying relevant trends in recorded images, and methods of displaying collected information in an easy to understand format.

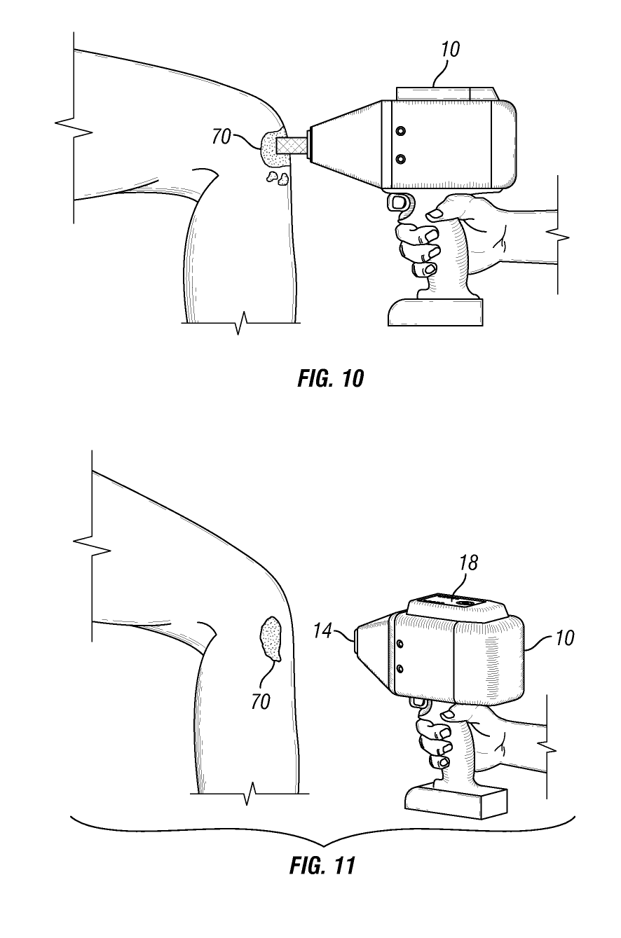

At the start of a particular treatment, the device 10 is powered and the target lesion of skin is suitably exposed in a manner effective to concentrate operation of the device 10 to substantially a target psoriatic lesion 70 and not toward any non-target regions of a patient's skin. As depicted in FIGS. 10 and 11, which illustrate device 10 orientation during treatment of a psoriatic lesion 70 along the knee of a patient, the patient may suitably bend the knee to form an apex type target skin surface of the lesion 70 to assist the healthcare provider in focusing the device 10 on the target lesion.

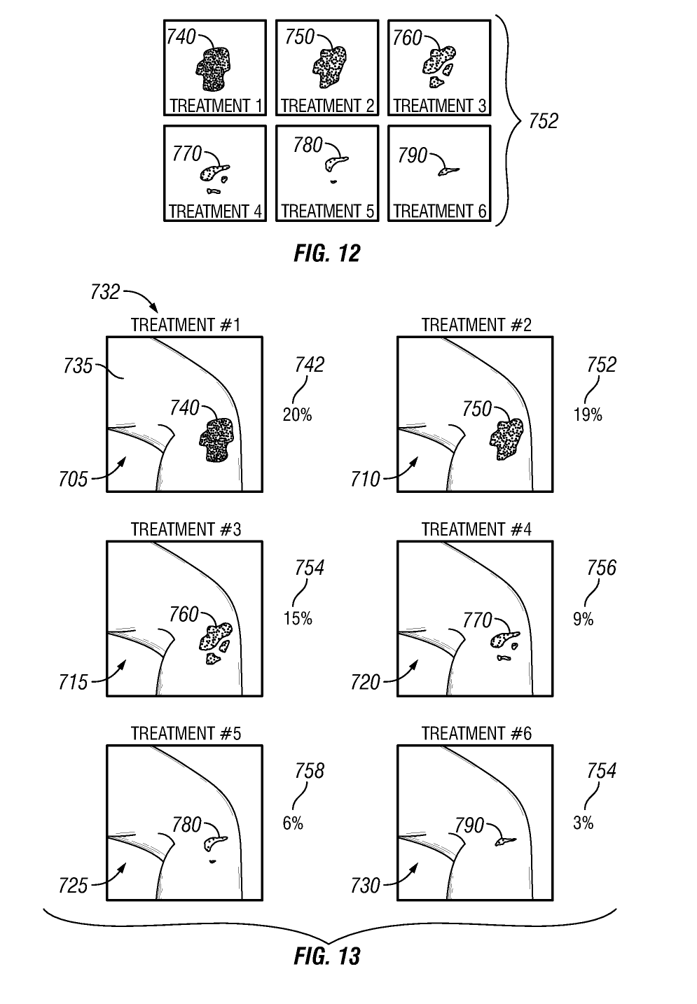

With continued reference to FIGS. 10 and 11, an exemplary treatment session progression of a lesion 70 is depicted. After entering patient record information and qualitative data for trend analysis into the device 10, the operator may then begin patient treatment. As each of these figures illustrate, the device 10 is suitably oriented in a manner effective to direct (1) the aperture 14, (2) the illumination source 13, (3) the distance sensor 17, and (4) the camera 16 toward the psoriatic lesion 70. As the device 10 is directed toward the lesion 70, the operator of the device 10 may view the lesion 70 in real time video or in one or a series of still images via the camera 16 and display screen 18, which is used as a view finder as common to digital point and shoot cameras and the like. Once the operator has focused the lesion 70 within the display screen 18 as desired, the operator may pull the trigger 23 capturing a digital image of the lesion 70, or in the alternative, the operator may activate the illumination source 13, e.g., a white light source in the form of an LED, to illuminate the lesion 70 for digital imaging purposes. A first image of an exemplary treatment is labeled “Treatment 1” in FIG. 12.

In addition, the distance sensor 17 may be implemented to relay recordable information to the device's 10 memory to record the distance between the camera 16 and the lesion 70 at the moment the first image is recorded. Thereafter, radiant energy, e.g., UV light, may be administered to the lesion 70. At a later treatment time or date, the distance sensor 17 and screen 18 may once again be employed to assist the operator to relocate the device 10 in substantially the same orientation (x and y axis) in relation to the device 10 as when the “Treatment 1” image was taken. By repeatedly relocating the device as to both orientation and scale as to previous treatment images, the present device 10 provides for consistent images of a lesion 70 for further treatment and diagnostic purposes. An exemplary series of lesion 70 treatments is depicted in FIGS. 12 and 13. As shown in FIG. 12, the device 10 is operationally configured to take successive images of a lesion 70 from substantially the same orientation in space relative to the lesion 70 as each of the preceding images.

Display of the lesion 70 suitably occurs prior to actual radiant energy administration to indicate the effect of the previous treatment or the current status of the lesion 70 prior to applying a successive energy dosing to the lesion 70. Once the operator records a satisfactory image, image data may be stored within the device's 10 memory or transmitted to a separate memory source found in a console 20, computer, and the like.

In addition to, or in the alternative, the display 18 may be operationally configured so that an operator may display a semi-translucent version of a previously recorded image overlaid upon a present real time image, as a means to assist an operator of the device 10 in lining up permanent landmarks or contours of the lesion 70, or adjacent skin, between treatments. In this respect, each new image is not only to scale but is also similar in orientation to previous images.

As stated previously, an operator of the device 10 may desire to illuminate a lesion 70 with a separate illumination source 13 to gather additional information not recordable via a naked photo or image. In one suitable embodiment, a lesion 70 may be illuminated with infrared light 13 to reveal underlying structures in the image for later analysis. For example, hemoglobin present in a person's blood carries oxygen molecules throughout the body. Oxygenated hemoglobin and deoxygenated hemoglobin preferentially absorb wavelengths of infrared light. Because the blood supply in a psoriatic lesion is greater than that of the surrounding healthy skin or tissue, a contrast between the two surfaces under infrared illumination may be observed. Under visible light, the color of a lesion 70, e.g. a red like color due to increased blood content, may be useful for identifying differences between healthy and psoriatic tissue. Using infrared illumination, the blood content of healthy skin and psoriatic legion 70 may be observed for more specific differentiation of the two surface types.

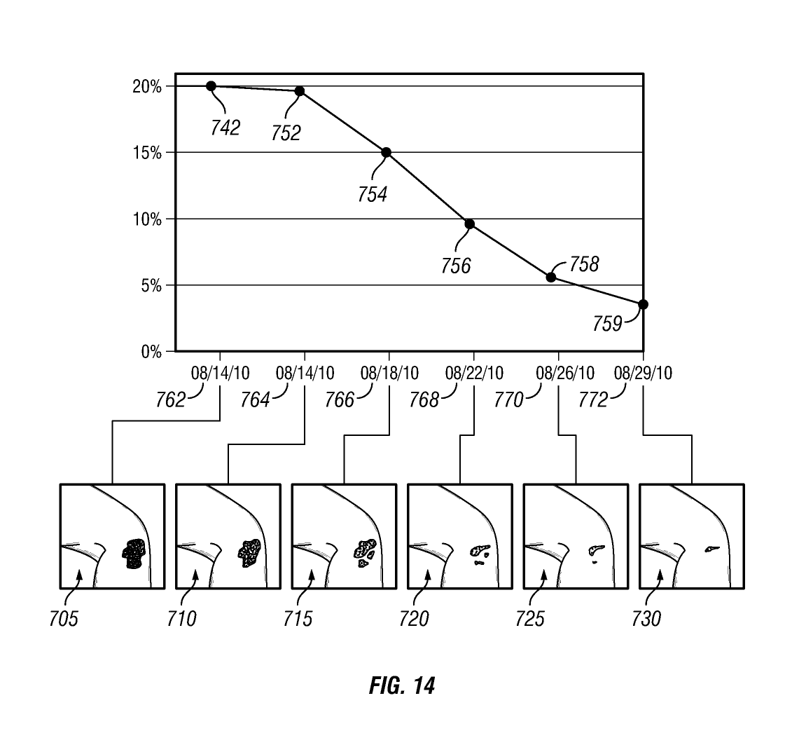

With reference to FIG. 14, the series of images of FIG. 13 taken over a series of treatments is shown with their corresponding graphical plot. For image processing purposes, the images may be analyzed via color, or may be reduced to gray scale as black and white images. Two exemplary methods are discussed here for quantifying differences in the images collected.

According to the first method, surface area may be utilized to identify a trend over time. With reference to FIGS. 12-14, a series of images 705, 710, 715, 720, 725, and 730 may be taken during successive treatments on one or more dates as shown by reference numerals 762, 764, 766, 768, 770, and 772. Suitably, the images 705, 710, 715, 720, 725, and 730 are collected in a manner effective to maintain scale and orientation similar as preceding images as described above. As to the first image 705, the device 10 is suitably operationally configured to determine the percentage (“%”) of the surface area of image 705 that is occupied by healthy skin 735 and the percentage of the image 705 that is occupied by the target lesion 740. The device 10 suitably normalizes the two percentages, and thereafter may determine the percentage of the lesion 740 in the image 5 (shown as 20% at 742). The device 10 repeats this process for the remaining images 710, 715, 720, 725, and 730, determining the percentage of each image occupied by the lesion (750, 760, 770, 780, and 790)—the corresponding percentages of these images being depicted by reference numerals 752, 754, 756, 758, and 759 respectively.

According to a second method, images 705, 710, 715, 720, 725, and 730 may be reduced to gray scale, and then the device 10 may be used to (1) determine the average shade of the healthy skin 735 from white to black, and (2) determine the average shade of the image 705 that is occupied by the target lesion 740, from white to black. As to image 705, the device 10 is suitably operationally configured to determine the contrast between the lesion 740 and healthy skin 735. As shown in the simplified illustration of FIG. 14, the lesion 740 is plotted as being 20.0% darker than the healthy tissue 735 (742 in FIG. 14). The device 10 may repeat this process for the remaining images 710, 715, 720, 725, and 730, determining the average shade of each image similar to the first image 705. The corresponding percentages for images 710, 715, 720, 725, and 730 are plotted as 752, 754, 756, 758, and 759. Suitably, targeted UV phototherapy using the present device 10 provides for healing of the lesion 740 whereby the shade or color of the lesion 740 approaches that of the healthy skin 735, the lesion 740 becoming less severe in the process as demonstrated in FIG. 13 at reference numerals 740, 750, 760, 770, 780, and 790.

In another embodiment, the device 10 may be used to record an image via infrared illumination or some other light source to reveal underlying structural changes, such as blood content in target skin. For example, since the blood supply of psoriatic lesions is often greater than that of healthy skin surfaces, wavelengths of light, including infrared light, may be directed to a lesion 70 whereby such light is suitably absorbed by the blood therein allowing the device 10 electronics to display or highlight, record, store and/or translate differences between healthy skin and unhealthy lesion type skin for quantifiable use. In one suitable implementation, quantifiable data gathered via the device 10 may be used for identifying trends in lesion 70 change or healing that may be plotted on a graph, such graph possibly being displayed adjacent the images on screen 18 for simple viewing and/or clinical use.

As shown in FIG. 14 a graph with plotted quantitative measures 742, 752, 754, 756, 758, and 759 plotted over time as a function of treatment frequency and treatment dates 762, 764, 766, 768, 770, and 772 may be displayed above the recorded images 705, 710, 715, 720, 725, and 730 as “thumbnail” images as understood by persons of ordinary skill in the graphic arts. In addition, percentage differences of each image between a lesion and healthy skin may be included within or adjacent each image. It is also contemplated that other trends or data may be displayed on the present device 10 using one or more graphs and other quantitative identifiers. For example data covering scores for pain, quality of sleep, pruritus, and the like, may be input into the device 10 and/or console 20 for use as desired. In addition, qualitative data, quantitative data, images, and combinations thereof, may be used to show at a treatment summary for an entire series of treatments in a user friendly format.

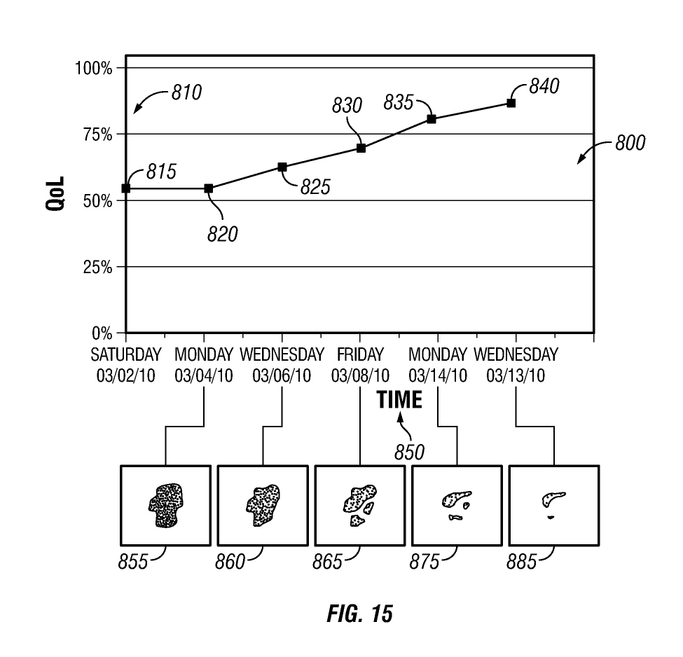

In another example of data use as shown in FIG. 15, QoL score per treatment session may be plotted over time and displayed with the recorded images 855, 860, 865, 875, and 885 taken prior to each treatment being located directly underneath each treatment date in the form of thumbnail images. As shown in this example, on a scale of 0% to 100%, 100% being highest QoL, the QoL is first ranked at slightly above 50% (see 815) upon a first treatment session and last ranked at 89% (see 840) after the final treatment in the series.

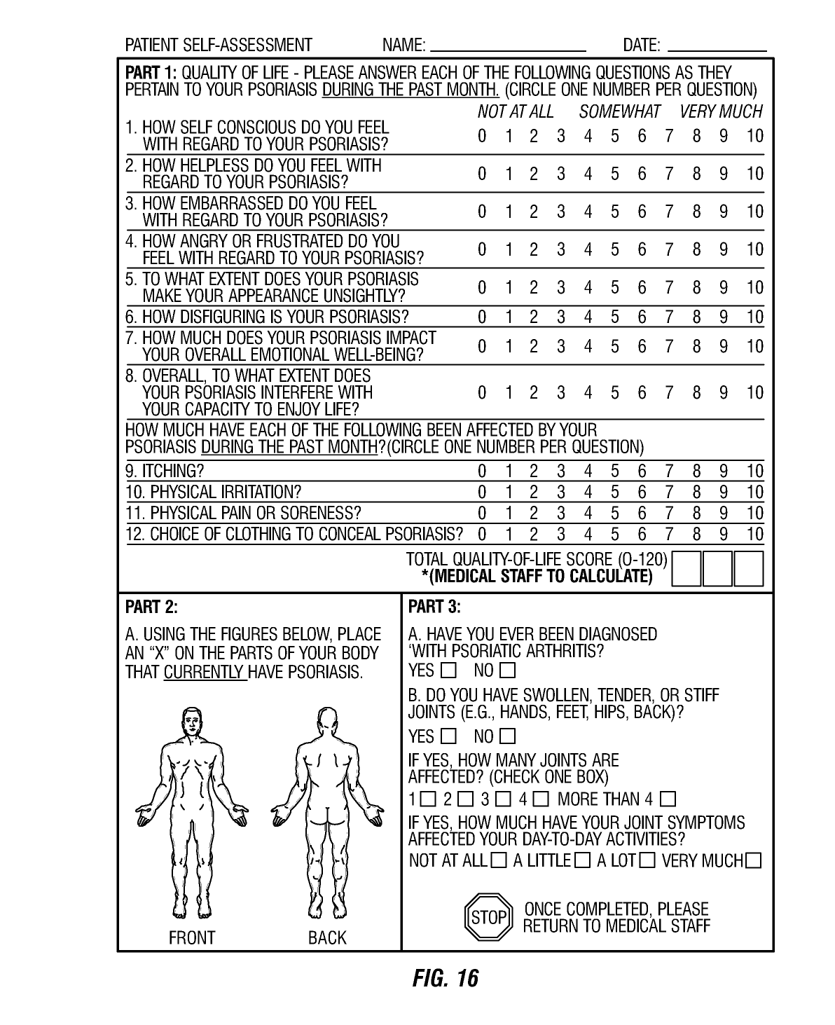

As an additional tool for plotting the information of FIG. 15, one or more questionnaires may be used to gather QoL information from a patient prior to administration of treatment with the device 10. FIG. 16 depicts a suitable QoL questionnaire for psoriasis patients for providing information to both a health care provider to assist in determining a proper course of treatment(s) for a patient, and to private or governmental insurers to assist in resource allocation, funding and reimbursement purposes. In clinical use, a questionnaire is suitably effective to provide persons of ordinary skill including, but not necessarily limited to dermatologists, tools for assessing severity, changes, and fluctuations of a patient's QoL.

Although the device 10 may be built to scale, the information displayed in FIGS. 14 and 15 used with a device 10 shown in FIGS. 8-11 is suitably viewable on a display screen 18 up to about 30.5 cm (about 12.0 inches) diagonal. Similar as with smart phones, persons may tap a particular image with their finger or other object to enlarge the information for detailed view as desired. In addition, persons may tap bring up other information such as QoL scores as desired.

In addition, the information including the graphs of FIGS. 14 and 15 may be printed to some predetermined digital format for digital record keeping or electronic data transfer, or to a printer for paper records. In one suitable embodiment, information shown in FIGS. 14 and 15 may be printed to a digital format or tangible medium, such document including for example, patient information, treatment information, a full list of qualitative data questionnaires for a patient, and full sized recorded images of one or more treatment sites as recorded using the device 10.

The invention will be better understood with reference to the following non-limiting examples, which are illustrative only and not intended to limit the present invention to a particular embodiment. The following examples discuss, for example, methods for (1) collecting qualitative data and recording images for medical treatment sessions, (2) identifying relevant trends in recorded images, and (3) displaying the collected information in an easy to understand format.

### Example 1

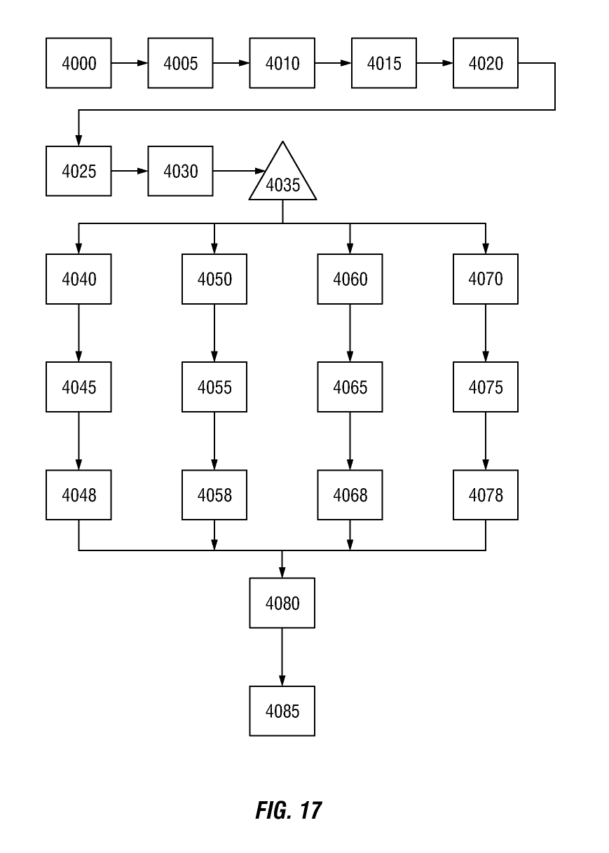

In a first non-limiting example, a psoriasis treatment device 10 as shown in FIG. 11 is provided including a display 18 for showing images and treatment data. With reference to FIG. 17, a flowchart is provided showing a standard progression for an operator of the device 10 from a point of turning the device 10 to an ON position, to a point where the operator begins to administer one or more radiant energy dosages to a target surface as explained in TABLE 1.

TABLE 1

| | |
|---|---|
| 4000 | Device is turned an ON position. |
| 4005 | User indicates “Treatment Setup” on a base console. |
| 4010 | Within Treatment Setup, the user selects a patient name from |
| | a database. |
| 4015 | The user updates treatment parameters. |
| 4020 | The user proceeds to the “Questionnaire Screen” |
| | and asks patient questions. The base console stores this |
| | gathered information. |
| 4025 | The user proceeds to “Initiate Treatment” |
| 4030 | The user, holding the handheld treatment device by the pistol- |
| | type grip is prompted to “Press Trigger to Collect Image”. |
| | The user may select to illuminate the treatment site with white |
| | light or infrared light at any time during image collection |
| | as desired. |
| 4035 | Depending on user settings either: |
| 4040 | Image Recall & Distance Recall is OFF, or First Patient Treatment |
| 4045 | The user may view an image or video as recorded by the camera |
| | of the device. Once the user has the camera lined up with the |
| | target surface as desired, the user may press the trigger and |
| | an audible “camera shutter” noise may be heard. |
| 4048 | If the user is satisfied with the image, the user may accept |
| | the image by pressing the trigger twice. If the user desires |
| | to re-take the image, he/she presses and holds the trigger. |
| 4050 | Image Recall is ON, Distance Recall is OFF. |
| 4055 | The user can see an image or video as recorded by the camera |
| | of the handheld on the screen. The user also can see a semi- |
| | translucent image of the previous treatment's image on |
| | the screen. The user lines the camera up with respect to the |
| | previous image, then presses the trigger, an audible “camera |
| | shutter” noise may be heard. |
| 4058 | If the user is satisfied with the image, they indicate acceptance |
| | by pressing the trigger twice. If they wish to re-take the image, |
| | they press and hold the trigger, an audible “camera shutter” |
| | noise being heard. |
| 4060 | Image Recall is OFF, Distance Recall is ON |
| 4065 | The user may see an image or video as recorded by the camera of |
| | the device on the display screen of the device. The user may also |
| | see a scale on the screen with an indicator of where the device |
| | was in relation to the target surface during preceding treatment |
| | image collection and where the device is currently. The user may |
| | suitably align the camera with respect to the previous distance |
| | recorded data, then press the trigger to record an image, an |
| | audible “camera shutter” noise being heard. |
| 4068 | If the user is satisfied with the image, the user may accept the |
| | image by pressing the trigger twice. If the user desires to re-take |
| | the image, he/she presses and holds the trigger. |
| 4070 | Image Recall is ON, Distance Recall is ON |
| 4075 | The user may see an image or video as recorded by the camera of |
| | the device on the display screen of the device. The user may also |
| | see a scale on the screen with an indicator of where the device |
| | was in relation to the target surface during preceding treatment |
| | image collection and where the device is currently. The user may |
| | also see a semi-translucent image of the previous treatment's |
| | image on the display screen of the device. The user may suitably |
| | align the camera with respect to the previous distance recorded |
| | data. The trigger to record an image, an audible “camera shutter” |
| | noise being heard. |
| 4078 | If the user is satisfied with the image, they indicate acceptance |
| | by pressing the trigger twice. If they wish to re-take the image, |
| | they press and hold the trigger, an audible “camera shutter” |
| | noise being heard. |
| 4080 | The base console stores the image to memory, and the user is |
| | prompted to “Begin Targeted UV Phototherapy” |
| 4085 | The “In Treatment” screen is displayed on the screen, |
| | and treatment begins as per normal. |

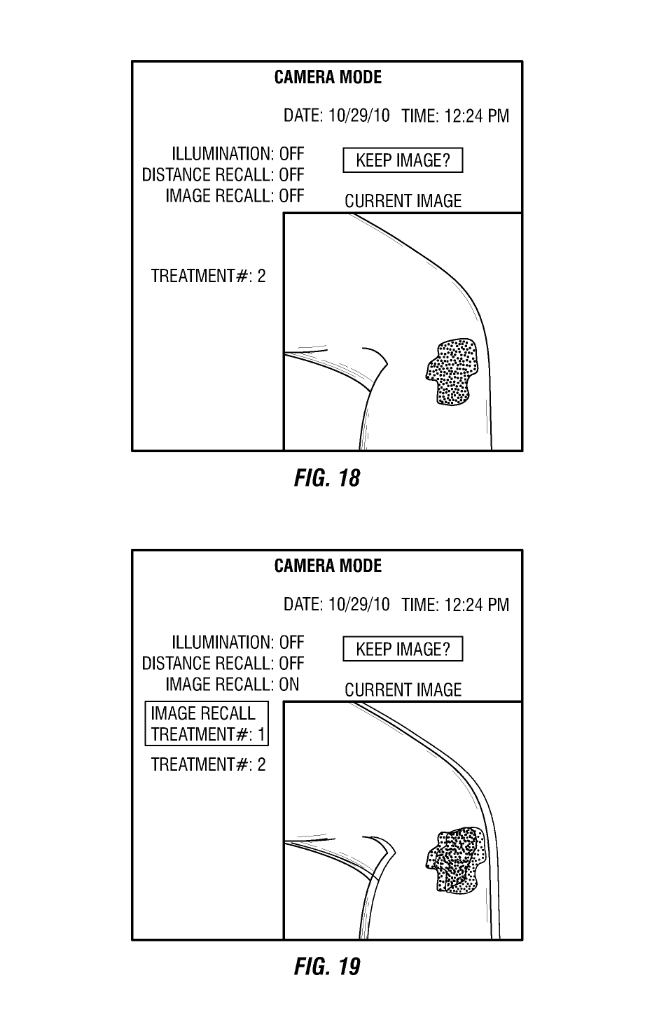

With reference to FIG. 18, the display screen 18 is shown while in “CAMERA MODE,” with the “ILLUMINATION,” “DISTANCE RECALL,” and “IMAGE RECALL” options set to OFF as shown. The display screen 18 displays the visual feedback image recorded by the camera 16 on the device 10 below “CURRENT IMAGE.” The “DATE” and “TIME” are displayed in the upper right section of the screen 18. The current treatment, in this case “TREATMENT 2” is displayed mid-screen to the left of the visual feedback image. A user captures an image by pressing the trigger 23 of the device 10. Thereafter, the user is prompted whether to save the image, shown as a “KEEP IMAGE?.” The user may tap the KEEP IMAGE? button or press the trigger 23 twice to save the image. If the user desires to retake the image, he/she holds the trigger for about 4.0 seconds at which time the device 10 will again display an image recorded by the camera 16.

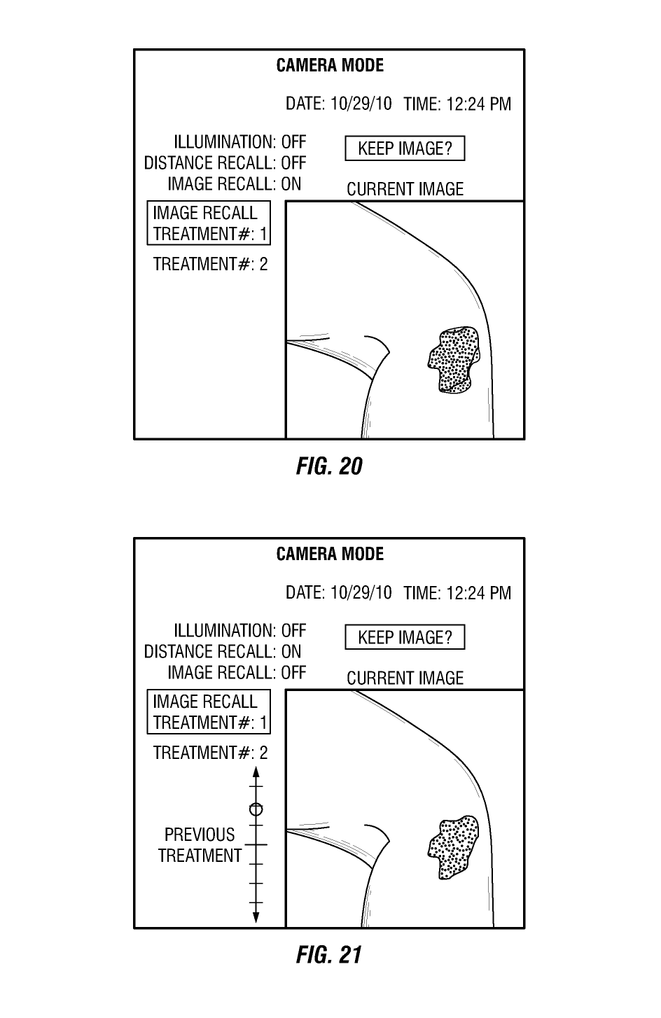

Turning to FIGS. 19 and 20, the screen of FIG. 20 in particular is shown in “CAMERA MODE,” with “IMAGE RECALL” set to ON and “DISTANCE RECALL” set to OFF. Similar as in FIG. 18, the screen 18 display screen 18 displays the visual feedback image recorded by the camera 16 on the device 10 below “CURRENT IMAGE,” along with the previous treatment image overlay in transparency. The “DATE” and “TIME” are displayed in the upper right section of the screen 18. Separate “ILLUMINATION” is set to OFF, and the “DISTANCE RECALL” option is set to OFF while “IMAGE RECALL” is set to ON. The current treatment, “TREATMENT 2” is displayed mid-screen on the left side. The overlay image option is indicated as “IMAGE RECALL TREATMENT #1”, which is the stored image of a previous treatment.

As shown by the visual feedback image of FIG. 19, the real time image of the target surface is offset from the stored overlay image recorded during a previous treatment. As shown in FIG. 19, the user utilizes the “IMAGE RECALL” option to properly line up lesion landmarks so that the camera 16 orientation in space is substantially similar to the orientation of the device when the previous image was recorded. As shown, the image overlay of the lesion appears larger in surface area, indicating that the lesion has reduced in size since the previous treatment.

The user records an image by pressing the trigger 23 and is then prompted whether to save the image or to delete the image by the option display option “KEEP IMAGE?.” The user may tap the KEEP IMAGE? button or press the trigger 23 twice to save the image. If the user desires to retake the image, he/she holds the trigger for about 4.0 seconds at which time the device 10 will again display an image recorded by the camera 16.

With reference to FIG. 21, the display screen 18 is shown in CAMERA MODE, with the “ILLUMINATION,” set to OFF, “DISTANCE RECALL,” set to ON, and “IMAGE RECALL” set to OFF as shown. Similar as in FIG. 18, the screen 18 display screen 18 displays the visual feedback image recorded by the camera 16 on the device 10 below “CURRENT IMAGE,” and the “DATE” and “TIME” are displayed in the upper right section of the screen 18. The current treatment, “TREATMENT 2” is displayed mid-screen on the left side. As “DISTANCE RECALL” is set to ON, the distance used is indicated above the current treatment in a box as “IMAGE RECALL TREATMENT #1”, which is the stored image of a previous treatment.

As shown, the scale “PREVIOUS TREATMENT” may be used to aligned a real time image according to the orientation in space of a previous recorded image, i.e., when the scale is centered. As the user moves the device 10 (and camera 16) closer to the target lesion than was measured for the previous treatment's image, the circle on the scale moves further away from the center in an upward direction as shown in FIG. 21. Likewise, if the user were to move the camera further away from the target surface than was measured during a previous recorded image, the circle on the scale would move further away in a downward direction from center.

The user records an image by pressing the trigger 23 and is then prompted whether to save the image or to delete the image by the option display option “KEEP IMAGE?.” The user may tap the KEEP IMAGE? button or press the trigger 23 twice to save the image. If the user desires to retake the image, he/she holds the trigger for about 4.0 seconds at which time the device 10 will again display an image recorded by the camera 16.

Either or both of the “IMAGE RECALL” and “DISTANCE SENSOR” features may be utilized to preserve scale and orientation for several images over a series of treatments.

### Example 2

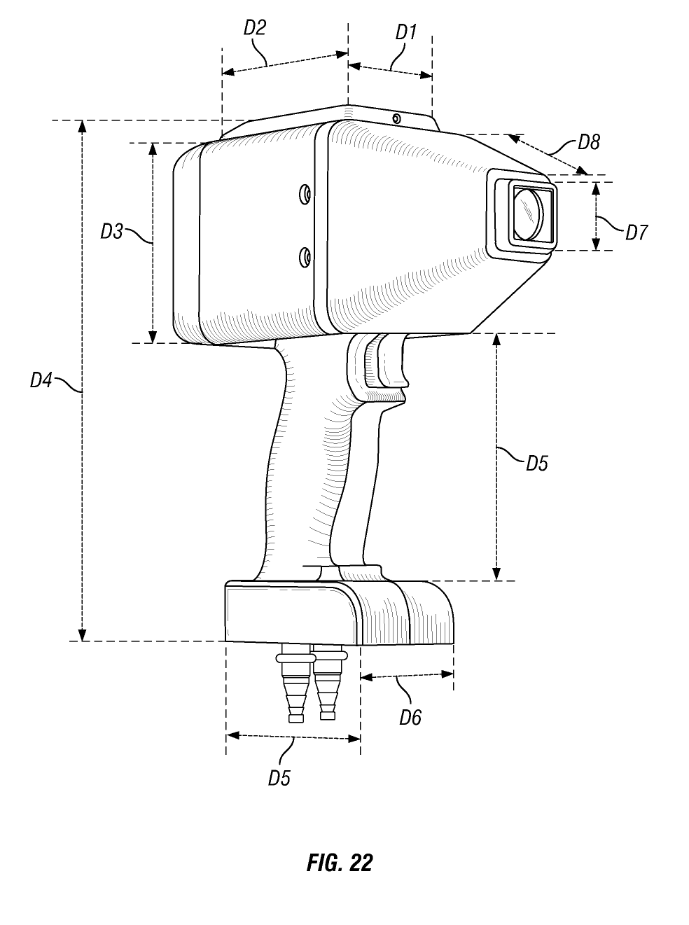

In a second non-limiting example, a hand held battery powered device 10 for treating skin conditions with UV light operationally configured to record images and other data, display images and other data including qualitative data and to provide trend analyses in an easy to understand format is provided. The device 10 is constructed from a rigid plastic by a molding process. With reference to FIG. 22, the device 10 is described as follows:

| | |
|---|---|
| D1: | about 5.08 cm (about 2.0 inches) |
| D2: | about 7.62 cm (about 3.0 inches) |
| D3: | about 8.26 cm (about 3.25 inches) |
| D4: | about 20.32 cm (about 8.0 inches) |
| D5: | about 8.89 cm (about 3.50 inches) |
| D6: | about 5.08 cm (about 2.0 inches) |
| D7: | about 2.54 cm (about 1.0 inches) |
| D8: | about 8.26 cm (about 3.25 inches) |
| Total Weight: | about 680 grams (about 24 ounces) |

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

We claim:

1. A radiant energy emitting device, comprising:
a targeting means operationally configured to repeatedly identify a target surface area;
an image recording means for recording one or more images of a target surface area; and
a powered energy source housed within the device operationally configured to emit energy;
wherein the device is operationally configured to concentrate energy emitted from the energy source out through an aperture of the device toward the target surface area.

2. The device of claim 1, wherein the targeting means includes a viewable screen operationally configured to display a real time view of a target surface area.

3. The device of claim 2, wherein the screen is operationally configured to display recorded images.

4. The device of claim 3, wherein the screen is operationally configured to overlay previously recorded images of the target surface area with a real time view of the target surface area for aligning to scale the real time view of the target surface area with a previously recorded image of the target surface area.

5. The device of claim 1, wherein the device is operationally configured to record images of a target surface area and emit energy toward the target surface area simultaneously.

6. The device of claim 1, wherein the energy source is operationally configured to emit non-visible light.

7. The device of claim 6, wherein non-visible light is selected from the group consisting of ultraviolet light, infrared light, and combinations thereof.

8. The device of claim 1, wherein the energy source is one or more light-emitting diodes emitting a wavelength from about 10 nm to about 400 nm.

9. The device of claim 1, wherein the image recording means is located adjacent the aperture.

10. The device of claim 1, wherein the device is operationally configured to determine color ratios of recorded images.

11. The device of claim 9, wherein the device is operationally configured to graphically plot target surface color absorption data according to recorded images.

12. The device of claim 1 operationally configured for ambidextrous use in both substantially vertical and substantially horizontal positions in space.

13. The device of claim 2, further including a pistol type grip handle including a trigger.

14. The device of claim 1, further including a distance sensor housed within the device operationally configured to detect the spatial relationship between the distance sensor and the target surface area.

15. A method for analyzing alterations to a target surface area treated with radiant energy over time, comprising:
providing a radiant energy emitting device, comprising (1) a targeting means operationally configured to repeatedly identify the target surface area, (2) an image recording means for recording one or more images of the target surface area, and (3) a powered energy source housed within the device operationally configured to emit energy, wherein the device is operationally configured to concentrate energy emitted from the energy source out through an aperture of the device toward the target surface area, and wherein the image recording means is located adjacent the aperture;
directing the aperture and image recording means toward a target surface area;
activating the image recording means to record one or more images of the target surface area to memory;
quantifying image color information of the target surface area;
directing the aperture and image recording means toward a target surface area using the targeting means;
activating the image recording means to record one or more images of the target surface area to memory;
quantifying image color information of the target surface area; and
comparing image color information of the images.

16. The method of claim 15, wherein the targeting means includes a distance sensor and a display screen operationally configured to relocate the device in substantially the same orientation and scale as device during recordation of the first image.

17. The method of claim 15, wherein the target surface area may be illuminated with infrared light during image recordation.

18. The method of claim 15, wherein non-image information may be input to the memory of the device and used in conjunction with image color information to assist the analysis of the target surface area.

19. A system for emitting radiant energy, comprising:
a radiant energy emitting device including (1) a targeting means operationally configured to repeatedly identify a target surface area; and (2) an image recording means for recording one or more images of a target surface area; and
a console in radiant communication with the device, the console housing a powered energy source operationally configured to emit energy;
wherein the device is operationally configured to concentrate energy emitted from the energy source out through an aperture of the device toward the target surface area; and
wherein the console is operationally configured to display image related information.

20. The system of claim 19, wherein the console includes electronic components operationally configured to translate differences in images for quantifiable use.
